(19) United States
(12) Patent Application Publication
(10) Pub. No.: US 2022/0081567 A1
(43) Pub. Date: Mar. 17, 2022

(54) THERMAL MANAGEMENT PHASE-CHANGE COMPOSITION, METHODS OF MANUFACTURE THEREOF, AND ARTICLES CONTAINING THE COMPOSITION

(71) Applicant: ROGERS CORPORATION, Chandler, AZ (US)

(72) Inventors: Ming Wei, Mansfield Center, CT (US); Ian Smith, Ashford, CT (US); Sharon Soong, Natick, MA (US)

(21) Appl. No.: 17/536,740

(22) Filed: Nov. 29, 2021

Related U.S. Application Data
(63) Continuation of application No. 16/434,502, filed on Jun. 7, 2019, now abandoned.
(60) Provisional application No. 62/681,810, filed on Jun. 7, 2018.

(51) Int. Cl. C08L 91/00; C08L 53/00; C08K 5/00; C08K 5/02; C08K 3/013; C08K 5/01; C08K 5/09; C08K 5/101; C08L 51/00; C08K 3/016

(52) U.S. Cl. CPC C08L 91/00; C08L 53/00; C08K 5/0066; C08K 5/005; C08K 5/02; C08K 3/013; C08K 2201/01; C08K 5/09; C08K 5/101; C08L 51/00; C08K 3/016; C08L 2207/04; C08K 5/01

(57) ABSTRACT

A phase-change composition comprises a homogeneous mixture of a thermoplastic polymer composition; and a phase-change material; wherein the phase-change composition has a viscosity of less than 100,000 centipoise, or less than 55,000 centipoise, or less than 30,000 centipoise, or less than 20,000 centipoise, or less than 10,000 centipoise, or less than 3000 centipoise at a temperature greater than or equal to 120° C. and is a gel at a temperature less than or equal to 100° C., or less than or equal to 80° C., or less than or equal to 50° C.

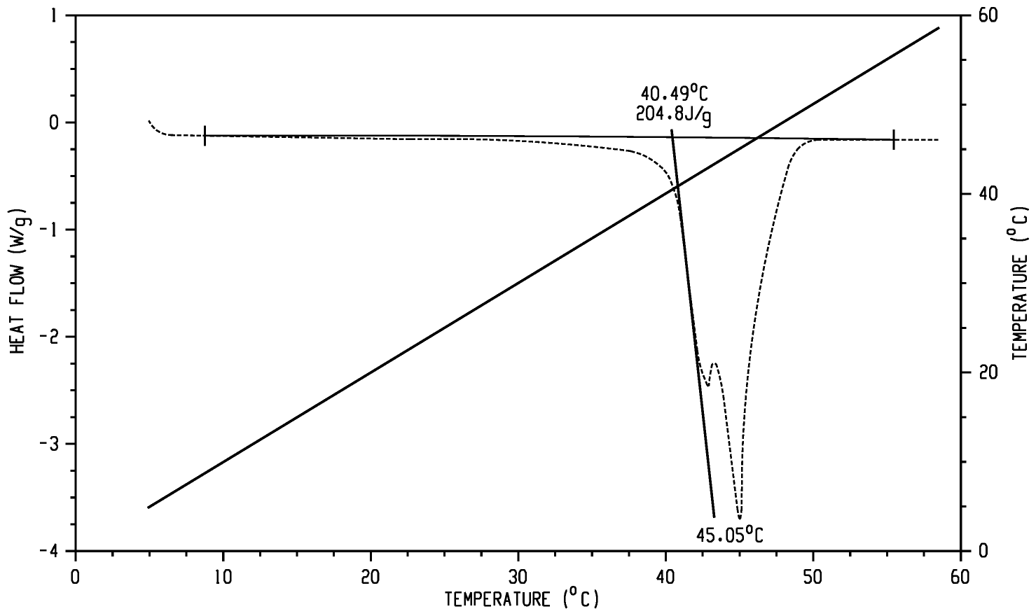

### CROSS REFERENCE TO RELATED APPLICATIONS

This application is a continuation application of U.S. patent application Ser. No. 16/434,502, filed Jun. 7, 2019, which claims the benefit of U.S. Patent Application No. 62/681,810, filed Jun. 7, 2018, both of which are incorporated by reference in their entirety herein.

### BACKGROUND

This disclosure relates to phase-change materials (PCMs), methods of manufacture thereof, and articles containing the PCMs.

Thermal management is desirable in a wide range of devices, including batteries, devices containing light-emitting diodes (LEDs), and devices containing circuits. For example, circuit designs for electronic devices such as televisions, radios, computers, medical instruments, business machines, and communications equipment have become increasingly smaller and thinner. The increasing power of such electronic components has resulted in increasing heat generation. Moreover, smaller electronic components are being densely packed into ever smaller spaces, resulting in more intense heat generation.

At the same time, electronic devices can be very sensitive to over-heating, negatively influencing both lifetime and reliability of the parts. Temperature-sensitive elements in electronic devices may need to be maintained within a prescribed operating temperature in order to avoid significant performance degradation or even system failure. Consequently, manufacturers are continuing to face the challenge of dissipating heat generated in electronic devices, i.e., thermal management. Moreover, the internal design of electronic devices may include irregularly shaped cavities that present a significant challenge for known thermal management approaches.

Accordingly, there remains a need for new approaches for thermal management in various devices, and particularly in electronic devices. It would be an additional advantage if the solutions were effective for small or thin devices or devices with irregularly shaped cavities.

### BRIEF SUMMARY

A phase-change composition comprises: a homogeneous mixture of a thermoplastic polymer composition; and a phase-change material; wherein the phase-change composition has a viscosity of less than 100,000 centipoise, or less than 55,000 centipoise, or less than 30,000 centipoise, or less than 20,000 centipoise, or less than 10,000 centipoise, or less than 3000 centipoise at a temperature greater than or equal to 120° C. and is a gel at a temperature less than or equal to 100° C., or less than or equal to 80° C., or less than or equal to 50° C.

A method of manufacturing the phase-change composition comprises combining a composition comprising a thermoplastic polymer composition and optionally a solvent, and molten phase-change material to form a mixture; cooling the mixture to provide a phase-change composition that is a gel at a temperature less than or equal to 100° C., or less than or equal to 80° C., or less than or equal to 50° C., or less than or equal to 30° C.; and optionally removing the solvent.

Also disclosed are articles comprising the phase-change composition.

A method of manufacturing an article comprising the phase-change composition comprises heating the phase-change composition at a temperature effective to provide a viscosity of less than 100,000 centipoise, or less than 55,000 centipoise, or less than 30,000 centipoise, or less than 20,000 centipoise, or less than 10,000 centipoise, or less than 3000 centipoise; introducing the heated phase-change composition into a cavity of an article; and cooling the inserted phase-change composition to form a gelled phase-change composition within the cavity.

The above described and other features are exemplified by the following FIGURE and detailed description.

### BRIEF DESCRIPTION OF THE DRAWING

The following is a brief description of the drawing, which is presented for the purposes of illustrating the exemplary embodiments disclosed herein and not for the purposes of limiting the same.

The FIGURE is a differential scanning calorimetry (DSC) trace, normalized heat flow (W/g) as a function of temperature (° C.), showing the heat of fusion (204.8 J/g) determined for the phase-change composition of the Example.

### DETAILED DESCRIPTION

The inventors hereof have developed phase-change compositions having a high heat of fusion at the phase transition temperature, and that are in gel form at low temperatures (less than or equal to 100° C.). The phase-change compositions further advantageously have a viscosity of less than 100,000 centipoise at a temperature of greater than or equal to 120° C. The phase-change compositions can therefore be easily introduced into a desired location of any shape by simple injection. Without being bound by theory, it is believed that these advantageous properties arise from use of a homogeneous mixture of a thermoplastic polymer composition dissolved in a phase-change material.

These phase-change compositions are especially suitable for providing excellent thermal protection to a wide variety of devices, and in particular electronic devices. The internal design of electronic devices can include irregularly shaped cavities that can be difficult to fill completely with solid phase-change materials to maximize heat absorption capacity. The phase-change compositions disclosed herein have the benefit that at higher temperature, above the operating temperature of the electronic device, the phase-change compositions flow and can be readily injected into irregularly shaped cavities in such devices in order to maximize heat absorption capacity. After cooling, the phase-change compositions are in gel form and therefore do not leak out of the device at the operating temperature of the device (e.g., less than 100° C. or less than 50° C.).

As stated above, the phase-change composition includes a homogeneous mixture of a thermoplastic polymer composition dissolved in a phase-change material. Optionally, the phase-change composition further comprises an additive composition. The phase-change material and the thermoplastic polymer composition are selected to have good compatibility, permitting a large amount of phase-change material to be present in a miscible blend with the thermoplastic polymer composition. The phase-change composition can be characterized as having a viscosity of less than 100,000 centipoise, or less than 55,000 centipoise, or less than 30,000 centipoise, or less than 20,000 centipoise, or less than 10,000 centipoise, or less than 3000 centipoise at a temperature greater than or equal to 120° C., and is a gel at a temperature less than or equal to 100° C., or less than or equal to 80° C., or less than or equal to 50° C., or less than or equal to 30° C., such that the phase-change composition does not exhibit appreciable flow at these temperatures.

A phase-change material (PCM) is a substance with a high heat of fusion, and that is capable of absorbing and releasing high amounts of latent heat during a phase transition, such as melting and solidification, respectively. During the phase change, the temperature of the phase-change material remains nearly constant. The phase-change material inhibits or stops the flow of thermal energy through the material during the time the phase-change material is absorbing or releasing heat, typically during the material's change of phase. In some instances, a phase-change material can inhibit heat transfer during a period of time when the phase-change material is absorbing or releasing heat, typically as the phase-change material undergoes a transition between two states. This action is typically transient and will occur until a latent heat of the phase-change material is absorbed or released during a heating or cooling process. Heat can be stored or removed from a phase-change material, and the phase-change material typically can be effectively recharged by a source of heat or cold.

Phase-change materials thus have a characteristic transition temperature. The term “transition temperature or “phase-change temperature” refers to an approximate temperature at which a material undergoes a transition between two states. In some embodiments, e.g. for a commercial paraffin wax of mixed composition, the transition “temperature” can be a temperature range over which the phase transition occurs.

In principle, it is possible to use phase-change materials having a phase-change temperature of −100 to 150° C. in the phase-change compositions. For use in LED and electronic components, in particular, the phase-change material incorporated into the phase-change compositions can have a phase-change temperature of 0 to 115° C., 10 to 105° C., 20 to 100° C., or 30 to 95° C. In an embodiment, the phase-change material has a melting temperature of 25 to 105° C., or 28 to 60° C., or 45 to 85° C., or 60 to 80° C., or 80 to 100° C.

The selection of a phase-change material typically depends upon the transition temperature that is desired for a particular application that is going to include the phase-change material. For example, a phase-change material having a transition temperature near normal body temperature or around 37° C. can be desirable for electronics applications to prevent user injury and protect overheating components. The phase-change material can have a transition temperature in the range of −5 to 150° C., or 0 to 90° C., or 30 to 70° C., or 35 to 50° C.

In other applications, for example a battery for an electric vehicle, a phase-change temperature of 65° C. or higher can be desirable. A phase-change material for such applications can have a transition temperature in the range of 45 to 85° C., or 60 to 80° C., or 80 to 100° C.

The transition temperature can be expanded or narrowed by modifying the purity of the phase-change material, molecular structure, blending of phase-change materials, or any combination thereof. By selecting two or more different phase-change materials and forming a mixture, the temperature stabilizing range of the phase-change material can be adjusted for any desired application. A temperature stabilizing range can include a specific transition temperature or a range of transition temperatures. The resulting mixture can exhibit two or more different transition temperatures or a single modified transition temperature when incorporated in the phase-change compositions described herein.

In some embodiments, it can be advantageous to have multiple or broad transition temperatures. If a single narrow transition temperature is used, this can cause thermal/energy buildup before the transition temperature is reached. Once the transition temperature is reached, then energy will be absorbed until the latent energy is consumed and the temperature will then continue to increase. Broad or multiple transition temperatures allow for temperature regulation and thermal absorption as soon the temperature starts to increase, thereby alleviating any thermal/energy buildup. Multiple or broad transition temperatures can also more efficiently help conduct heat away from a component by overlapping or staggering thermal absorptions. For instance, for a composition containing a first phase-change material (PCM1) which absorbs at 35 to 40° C. and a second phase-change material (PCM2) which absorbs at 38 to 45° C., PCM1 will start absorbing and controlling temperature until a majority of the latent heat is used, at which time PCM2 will start to absorb and conduct energy from PCM1 thereby rejuvenating PCM1 and allowing it to keep functioning.

The selection of the phase-change material can depend on the latent heat of the phase-change material. A latent heat of the phase-change material typically correlates with its ability to absorb and release energy/heat or modify the heat transfer properties of the article. In some instances, the phase-change material can have a latent heat of fusion that is at least 80 Joules/gram (J/g), or at least 100 J/g, or at least 120 J/g, or at least 140 J/g, or at least 150 J/g, or at least 170 J/g, or at least 180 J/g, or at least 185 J/g, or at least 190 J/g, or at least 200 J/g, or at least 220 J/g. Thus, for example, the phase-change material can have a latent heat of fusion of 20 J/g to 400 J/g, such as 80 J/g to 400 J/g, or 100 J/g to 400 J/g, or 150 J/g to 400 J/g, or 170 J/g to 400 J/g, or 190 J/g to 400 J/g.

Phase-change materials that can be used include various organic and inorganic substances. Examples of phase-change materials include hydrocarbons (e.g., straight-chain alkanes or paraffinic hydrocarbons, branched-chain alkanes, unsaturated hydrocarbons, halogenated hydrocarbons, and alicyclic hydrocarbons), silicone wax, alkanes, alkenes, alkynes, arenes, hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, saturated and unsaturated fatty acids for example, caproic acid, caprylic acid, lauric acid, myristic acid, palmitic acid, stearic acid, arachidic acid, behenic acid, lignoceric acid cerotic acid, and the like), fatty acid esters (for example, fatty acid C₁-C₄ alkyl esters, such as methyl caprylate, methyl caprate, methyl laurate, methyl myristate, methyl palmitate, methyl stearate, methyl arachidate, methyl behenate, methyl lignocerate, and the like), fatty alcohols (for example, capryl alcohol, lauryl alcohol, myristyl alcohol, cetyl alcohol, stearyl alcohol, arachidyl alcohol, behenyl alcohol, lignoceryl alcohol, ceryl alcohol, montanyl alcohol, myricyl alcohol, and geddyl alcohol, and the like), dibasic acids, dibasic esters, 1-halides, primary alcohols, secondary alcohols, tertiary alcohols, aromatic compounds, clathrates, semi-clathrates, gas clathrates, anhydrides (e.g., stearic anhydride), ethylene carbonate, methyl esters, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), sugar alcohols (erythritol, D-mannitol, galactitol, xylitol, D-sorbitol), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers including polyethylene, polyethylene glycol, polyethylene oxide, polypropylene, polypropylene glycol, or polytetramethylene glycol), metals, and mixtures thereof. Various vegetable oils can be used, for example soybean oils, palm oils, or the like. Such oils can be purified or otherwise treated to render them suitable for use as phase-change materials. In an embodiment a phase-change material used in the phase-change composition is an organic substance.

Paraffinic phase-change materials can be a paraffinic hydrocarbon, that is, a hydrocarbon represented by the formula CₙHₙ₊₂, where n can range from 10 to 44 carbon atoms. The melting point and heat of fusion of a homologous series of paraffin hydrocarbons is directly related to the number of carbon atoms, as shown in the following table.

TABLE 1
Melting Points of Paraffinic Hydrocarbons

| Paraffinic Hydrocarbon | No. of Carbon Atoms | Melting Point (° C.) |
|---|---|---|
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

Similarly, the melting point of a fatty acid depends on the chain length.

In an embodiment, the phase-change material comprises a paraffinic hydrocarbon, a fatty acid, or a fatty acid ester having 15 to 40 carbon atoms, 18 to 35 carbon atoms, or 18 to 28 carbon atoms. The phase-change material can be a single paraffinic hydrocarbon, fatty acid, or fatty acid ester, or a mixture of hydrocarbons, fatty acids, and/or fatty acid esters. The phase-change material can be a vegetable oil. In a preferred embodiment the phase-change material has a melting temperature of 5 to 70° C., 25 to 65° C., 35 to 60° C., or 30 to 50° C.

The heat of fusion of the phase-change material, determined by differential scanning calorimetry according to ASTM D3418, can be greater than 150 Joules/gram, preferably greater than 180 Joules per gram, more preferably greater than 200 Joules/gram

The phase-change material includes an unencapsulated (“raw”) phase change material, although encapsulated phase-change materials can also be present as describe in further detail below. The amount of the unencapsulated phase-change material depends on the type of material used, the desired phase change temperature, the type of thermoplastic polymer used, and like considerations, but is selected to provide a miscible blend of the phase-change material and the thermoplastic polymer after mixing. The amount of the unencapsulated phase-change material can be 50 to 97 weight percent, or 55 to 95 weight percent, or 60 to 90 weight percent of the total weight of the unencapsulated phase-change material and the thermoplastic polymer, provided that a miscible blend of the phase-change material and the thermoplastic polymer is formed after mixing. In an embodiment, an amount of the unencapsulated phase-change material can be 60 to 97 weight percent, or 55 to 97 weight percent, or 65 to 95 weight percent, or 60 to 90 weight percent of the total weight of the unencapsulated phase-change material and the thermoplastic polymer, provided that a miscible blend of the phase-change composition and the thermoplastic polymer is formed after mixing. In a preferred embodiment a large amount of an unencapsulated phase-change material is present, in particular 70 to 97 weight percent, or 85 to 97 weight percent, or 80 to 97 weight percent, or even 90 to 97 weight percent, based on the total weight of the unencapsulated phase-change material and the thermoplastic polymer.

The phase-change composition further comprises a thermoplastic polymer composition in combination with the unencapsulated phase change material. As used herein, “polymer” includes oligomers, ionomers, dendrimers, homopolymers, and copolymers (such as graft copolymers, random copolymers, block copolymers (e.g., star block copolymers, random copolymers, and the like. The thermoplastic polymer composition can be a single polymer or a combination of polymers. The combination of polymers can be, for example, a blend of two or more polymers having different chemical compositions, different weight average molecular weights, or a combination of the foregoing. Careful selection of the polymer or of the combination of polymers allows for tuning of the properties of the phase-change compositions.

The type and amount of thermoplastic polymer composition is selected to have good compatibility with the phase-change material, in order to form a miscible blend of the thermoplastic polymer composition and a large quantity of the phase-change material, e.g., at least 50% by weight, or at least 70% by weight, or at least 80% by weight, or even at least 90% by weight. If a combination of two or more polymers is used, the polymers are preferably miscible, or are miscible when combined with the phase-change material. The thermoplastic polymer composition can also be selected to provide a desired gelling temperature.

It has been unexpectedly found that careful selection of the thermoplastic polymer composition to provide a miscible blend with large quantities of the unencapsulated phase-change material provides a product that is a gel at lower temperatures but has low viscosity at higher temperatures. A “gel” or “gelled phase-change composition” as used herein means a physical state that does not exhibit significant flow at steady state at a given temperature. Preferably the gel or gelled phase-change composition does not exhibit appreciable flow at steady state at a given temperature. Thus, the thermoplastic polymer composition, the unencapsulated phase-change material, and any additives as described in more detail below are selected such that the resultant phase-change composition intended for use in an article, such as an electronic device, is in a gel state across the operating temperature range of the article. That is, the thermoplastic polymer composition and the unencapsulated phase-change material are selected such that the gel temperature of the resultant phase-change composition is the maximal operating temperature expected for the device. The gel temperature is the temperature threshold for formation of the thermoreversible gel in the polymer composition. For example, the operating temperature of the article can be in the range of 10 to 100° C., 15 to 85° C., or 20 to 70° C. The phase-change composition can accordingly be introduced into a cavity in an article as a fluid at temperatures above the operating temperature range of the article (above the gel temperature of the phase-change composition), but at temperatures within the operating temperature range of the article, which will be at or below the gel temperature of the phase-change composition. In a highly advantageous feature, the phase-change composition exists as a gel and therefore does not leak from the article. The phase-change composition can accordingly be inserted into a cavity in such an article as a fluid at temperatures of at least 120° C., but then forms a gel that does not substantially flow at temperatures of 100° C. or less. The capacity of the phase-change composition to efficiently retain the phase-change material within its own matrix can confer to the phase-change compositions an excellent heat management performance over long periods of time.

In an embodiment, the thermoplastic polymer composition has low polarity. Low polarity of the thermoplastic polymer composition enables compatibility with a phase-change material of a non-polar nature.

One parameter that can be used to assess compatibility of the polymer composition with the unencapsulated phase-change material is the “solubility parameter” (δ) of the polymer composition and the phase-change material. Solubility parameters can be determined by any known method in the art or obtained for many polymers and phase-change materials from published tables. The polymer composition and phase-change material generally have similar solubility parameters to form a miscible blend. The solubility parameter (δ) of the polymer composition can be within ±1, or ±0.9, or ±0.8, or ±0.7, or ±0.6, or ±0.5, or ±0.4, or ±0.3 of the solubility parameter of the unencapsulated phase-change material.

A wide variety of thermoplastic polymers can be used, alone or in combination, in the thermoplastic polymer composition depending on the phase-change material and other desired characteristics of the phase-change composition. Exemplary polymers that are generally considered thermoplastic include cyclic olefin polymers (including polynorbornenes and copolymers containing norbornenyl units, for example copolymers of a cyclic polymer such as norbornene and an acyclic olefin such as ethylene or propylene), fluoropolymers (e.g., polyvinyl fluoride (PVF), polyvinylidene fluoride (PVDF), fluorinated ethylene-propylene (FEP), polytetrafluoroethylene (PTFE), poly(ethylene-tetrafluoroethylene (PETFE), perfluoroalkoxy (PFA)), polyacetals (e.g., polyoxyethylene and polyoxymethylene), poly(C₁₋₆ alkyl)acrylates, polyacrylamides (including unsubstituted and mono-N- and di-N—(C₁₋₈ alkyl)acrylamides), polyacrylonitriles, polyamides (e.g., aliphatic polyamides, polyphthalamides, and polyaramides), polyamideimides, polyanhydrides, polyarylene ethers (e.g., polyphenylene ethers), polyarylene ether ketones (e.g., polyether ether ketones (PEEK) and polyether ketone ketones (PEKK)), polyarylene ketones, polyarylene sulfides (e.g., polyphenylene sulfides (PPS)), polyarylene sulfones (e.g., polyethersulfones (PES), polyphenylene sulfones (PPS), and the like), polybenzothiazoles, polybenzoxazoles, polybenzimidazoles, polycarbonates (including homopolycarbonates and polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetherimides (including copolymers such as polyetherimide-siloxane copolymers), polyimides (including copolymers such as polyimide-siloxane copolymers), poly(C₁₋₆ alkyl)methacrylates, polymethacrylamides (including unsubstituted and mono-N- and di-N—(C₁₋₈ alkyl)acrylamides), polyolefins (e.g., polyethylenes, polypropylenes, and their halogenated derivatives (such as polytetrafluoroethylenes), and their copolymers, for example ethylene-alpha-olefin copolymers, poly(ethylene-vinyl acetate), polyoxadiazoles, polyoxymethylenes, polyphthalides, polysilazanes, polysiloxanes (silicones), polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, vinyl polymers (including polyvinyl alcohols, polyvinyl esters, polyvinyl ethers, polyvinyl halides (e.g, polyvinyl fluoride), polyvinyl ketones, polyvinyl nitriles, polyvinyl thioethers, and polyvinylidene fluorides), or the like. A combination comprising at least one of the foregoing polymers can be used.

A preferred type of polymer is an elastomer, which can be optionally crosslinked. In some embodiments, use of a crosslinked (i.e., cured) elastomer provides lower flow of the phase-change compositions at higher temperatures. Suitable elastomers can be elastomeric random, grafted, or block copolymers. Examples include natural rubber/isoprene, butyl rubber, polydicyclopentadiene rubber, fluoroelastomers, ethylene-propylene rubber (EPR), ethylene-butene rubber, ethylene-propylene-diene monomer rubber (EPDM, or ethylene propylene diene terpolymer), acrylate rubbers, nitrile rubber, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-butadiene-styrene (ABS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), polyurethane, silicone, acrylate and the like.

Elastomeric block copolymers comprise a block (A) derived from an alkenyl aromatic compound and a block (B) derived from a conjugated diene. The arrangement of blocks (A) and (B) include linear and graft structures, including radial tetrablock structures having branched chains. Examples of linear structures include diblock (A-B), triblock (A-B-A or B-A-B), tetrablock (A-B-A-B), and pentablock (A-B-A-B-A or B-A-B-A-B) structures as well as linear structures containing 6 or more blocks in total of A and B. Specific block copolymers include diblock, triblock, and tetrablock structures, and specifically the A-B diblock and A-B-A triblock structures. In some embodiments, the elastomer is a styrenic block copolymer (SBC) consisting of polystyrene blocks and rubber blocks. The rubber blocks can be polybutadiene, polyisoprene, their hydrogenated equivalents, or a combination thereof. Examples of styrenic block copolymers include styrene-butadiene block copolymers, e.g. Kraton D SBS polymers (Kraton Performance Polymers, Inc.); styrene-ethylene/propylene block copolymers, e.g., Kraton G SEPS (Kraton Performance Polymers, Inc.) or styrene-ethylene/butadiene block copolymers, e.g., Kraton G SEBS (Kraton Performance Polymers, Inc.); and styrene-isoprene block copolymers, e.g., Kraton D SIS polymers (Kraton Performance Polymers, Inc.). In certain embodiments, the polymer is a styrene-ethylene-butadiene-styrene block copolymer, e.g., Kraton G 1726. In other embodiments, the polymer is a styrene butadiene block copolymer, e.g. Kraton D1192.

In certain embodiments, the polymer is Kraton G SEBS or SEPS, a styrene-butadiene block copolymer, polybutadiene, EPDM, natural rubber, butyl rubber, cyclic olefin copolymer, polydicyclopentadiene rubber, or a combination comprising one or more of the foregoing.

The combination of the unencapsulated phase change material and the thermoplastic polymer composition can be a gel at a temperature of less than or equal to 100° C., or less than or equal to 80° C., or less than or equal to 50° C., and can have a viscosity of less than 100,000 centipoise, or less than 55,000 centipoise, or less than 30,000 centipoise, or less than 20,000 centipoise, or less than 10,000 centipoise, or less than 3000 centipoise at temperatures of at least 120° C. In an embodiment, the combination of the unencapsulated phase change material and the thermoplastic polymer composition is a gel at a temperature of less than or equal to 80° C., or less than or equal to 50° C., and has a viscosity of less than 55,000 centipoise, or less than 30,000 centipoise, or less than 20,000 centipoise, or less than 10,000 centipoise, or less than 3000 centipoise at temperatures of 120° C. In another embodiment, the combination of the unencapsulated phase-change material and the thermoplastic polymer composition is a gel at a temperature of less than or equal to 50° C., or less than or equal to 30° C., and has a viscosity of less than 30,000 centipoise, or less than 20,000 centipoise, or less than 10,000 centipoise, or less than 3000 centipoise at temperatures of 120° C. The combination of the unencapsulated phase-change material and the thermoplastic polymer composition is a gel at a temperature above 25° C., or above 30° C., or above 40° C.

The combination of the unencapsulated phase-change material and the thermoplastic polymer composition can be characterized by a heat of fusion, determined by differential scanning calorimetry according to ASTM D3418, of greater than 150 Joules/gram, preferably greater than 180 Joules per gram, more preferably greater than 200 Joules/gram.

In some embodiments, the phase-change composition can meet the UL94 VTM-2 flammability standard.

The phase-change compositions can consist, or consist essentially of, the combination of the unencapsulated phase-change material and the thermoplastic polymer composition alone, in the amounts described above. Alternatively, the phase-change compositions can further comprise other components as additives, for example an encapsulated phase-change material, a filler, or other additives known in the art. Such additional components are selected so as to not significantly adversely affect the desired properties of the phase-change compositions, in particular the recited gelling and viscosity properties.

For example, although the phase-change composition comprises an unencapsulated phase-change material, the phase-change composition can further include a phase-change material in an encapsulated form as an additive. Encapsulation of a phase-change material essentially creates a container for the phase-change material so that regardless of whether the phase-change material is in the solid or liquid state, the phase-change material is contained. Methods for encapsulating materials, such as phase-change materials, are known in the art (see for example, U.S. Pat. Nos. 5,911,923 and 6,703,127). Microencapsulated and macroencapsulated phase-change materials are also available commercially (e.g., from Microtek Laboratories, Inc.) Macrocapsules have an average particle size of 1000 to 10,000 micrometers, whereas microcapsules have an average particle size less than 1000 micrometers. The encapsulated phase-change material can be encapsulated in a microcapsule and the mean particle size of the microcapsules can be 1 to 100 micrometers, or 2 to 50 micrometers, or 5 to 40 micrometers. Herein, mean particle size of an encapsulated PCM is a volume weighted mean particle size, determined for example using a Malvern Mastersizer 2000 Particle Analyzer, or equivalent instrumentation. The encapsulated phase-change material can be included in an amount of 1 to 50 weight percent, specifically 1 to 40 weight percent, or 5 to 30 weight percent, or 10 to 30 weight percent, each based on a total weight of the phase-change composition.

The phase-change composition can further comprise a filler, for example a filler to adjust the dielectric, thermally conductive, or magnetic properties of the phase-change composition. A low coefficient of expansion filler, such as glass beads, silica or ground micro-glass fibers, can be used. A thermally stable fiber, such as an aromatic polyamide, or a polyacrylonitrile can be used. Representative dielectric fillers include titanium dioxide (rutile and anatase), barium titanate, strontium titanate, fused amorphous silica, corundum, wollastonite, aramide fibers (e.g., KEVLAR™ from DuPont), fiberglass, Ba₂Ti₉O₂₀, quartz, aluminum nitride, silicon carbide, beryllia, alumina, magnesia, mica, talcs, nanoclays, aluminosilicates (natural and synthetic), iron oxide, CoFe₂O₄ (nanostructured powder available from Nanostructured & Amorphous Materials, Inc.), single wall or multiwall carbon nanotubes, and fumed silicon dioxide (e.g., Cab-O-Sil, available from Cabot Corporation), each of which can be used alone or in combination.

Other types of fillers that can be used include a thermoconductive filler, a thermally insulating filler, a magnetic filler, or a combination thereof. Thermoconductive fillers include, for example, boron nitride, silica, alumina, zinc oxide, magnesium oxide, and aluminum nitride. Examples of thermally insulating fillers include, for example, organic polymers in particulate form. The magnetic fillers can be nanosized.

The fillers can be in the form of solid, porous, or hollow particles. The particle size of the filler affects a number of important properties including coefficient of thermal expansion, modulus, elongation, and flame resistance. In an embodiment, the filler has an average particle size of 0.1 to 15 micrometers, specifically 0.2 to 10 micrometers. The filler can be a nanoparticle, i.e., a nanofiller, having an average particle size of 1 to 100 nanometers (nm), or 5 to 90 nm, or 10 to 80 nm, or 20 to 60 nm. A combination of fillers having a bimodal, trimodal, or higher average particle size distribution can be used. The filler can be included in an amount of 0.5 to 60 weight percent, or 1 to 50 weight percent, or 5 to 40 weight percent, based on a total weight of the phase-change composition.

In addition to the optional encapsulated phase-change material, and optional filler as described above, the phase-change composition can further optionally comprise additives such as flame retardants, cure initiators, crosslinking agents, viscosity modifiers, wetting agents, antioxidants, thermal stabilizers, colorants, or a combination thereof. The particular choice of additives depends on the polymer used, the particular application of the phase-change composition, and the desired properties for that application, and are selected so as to enhance or not substantially adversely affect the electrical properties of the circuit subassemblies, such as thermal conductivity, dielectric constant, dissipation factor, dielectric loss, or other desired properties.

The flame retardant can be a metal carbonate, a metal hydrate, a metal oxide, a halogenated organic compound, an organic phosphorus-containing compound, a nitrogen-containing compound, or a phosphinate salt. Representative flame retardant additives include bromine-, phosphorus-, and metal oxide-containing flame retardants. Suitable bromine-containing flame retardants are generally aromatic and contain at least two bromines per compound. Some that are commercially available are from, for example, Albemarle Corporation under trade names Saytex BT-93W (ethylenebistetrabromophthalimide), Saytex 120 (tetradecaboromodiphenoxybenzene), and Great Lake under trade name BC-52, BC-58, Esschem Inc under the trade name FR1025.

Suitable phosphorus-containing flame retardants include various organic phosphorous compounds, for example an aromatic phosphate of the formula (GO)₃P═O, wherein each G is independently an C₁₋₃₆ alkyl, cycloalkyl, aryl, alkylaryl, or arylalkyl group, provided that at least one G is an aromatic group. Two of the G groups can be joined together to provide a cyclic group, for example, diphenyl pentaerythritol diphosphate. Other suitable aromatic phosphates can be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like. Examples of suitable di- or polyfunctional aromatic phosphorous-containing compounds include resorcinol tetraphenyl diphosphate (RDP), the bis (diphenyl) phosphate of hydroquinone, and the bis(diphenyl) phosphate of bisphenol-A, respectively, their oligomeric and polymeric counterparts, and the like.

Metal phosphinate salts can also be used. Examples of phosphinates are phosphinate salts such as for example alicyclic phosphinate salts and phosphinate esters. Further examples of phosphinates are diphosphinic acids, dimethylphosphinic acid, ethylmethylphosphinic acid, diethylphosphinic acid, and the salts of these acids, such as for example the aluminum salts and the zinc salts. Examples of phosphine oxides are isobutylbis(hydroxyalkyl) phosphine oxide and 1,4-diisobutylene-2,3,5,6-tetrahydroxy-1,4-diphosphine oxide or 1,4-diisobutylene-1,4-diphosphoryl-2,3,5,6-tetrahydroxycyclohexane. Further examples of phosphorous-containing compounds are NH1197® (Chemtura Corporation), NH15110 (Chemtura Corporation), NcendX P-30® (Albemarle), Hostaflam OP5500® (Clariant), Hostaflam OP910® (Clariant), EXOLIT 935 (Clariant), and Cyagard RF 1204®, Cyagard RF 1241® and Cyagard RF 1243R (Cyagard are products of Cytec Industries). In a particularly advantageous embodiment, a halogen-free phase-change composition has excellent flame retardance when used with EXOLIT 935 (an aluminum phosphinate). Still other flame retardants include melamine polyphosphate, melamine cyanurate, Melam, Melon, Melem, guanidines, phosphazanes, silazanes, DOPO (9,10-dihydro-9-oxa-10 phosphaphenanthrene-10-oxide), and 10-(2,5 dihydroxyphenyl)-10H-9-oxa-phosphaphenanthrene-10-oxide.

Suitable metal oxide flame retardants are magnesium hydroxide, aluminum hydroxide, zinc stannate, and boron oxide. Preferably, the flame retardant can be aluminum trihydroxide, magnesium hydroxide, antimony oxide, decabromodiphenyl oxide, decabromodiphenyl ethane, ethylene-bis (tetrabromophthalimide), melamine, zinc stannate, or boron oxide.

A flame retardant additive can be present in an amount known in the art for the particular type of additive used. In an embodiment the flame retardant type and amount is selected to provide a phase-change composition that can pass the UL94 VTM-2 standard when consolidated to a thickness of 1.5 millimeters.

Exemplary cure initiators include those useful in initiating cure (cross-linking) of the polymers, in the phase-change composition. Examples include, but are not limited to, azides, amine, peroxides, sulfur, and sulfur derivatives. Free radical initiators are especially desirable as cure initiators. Examples of free radical initiators include peroxides, hydroperoxides, and non-peroxide initiators such as 2,3-dimethyl-2,3-diphenyl butane. Examples of peroxide curing agents include dicumyl peroxide, alpha, alpha-di(t-butylperoxy)-m,p-diisopropylbenzene, 2,5-dimethyl-2,5-di(t-butylperoxy)hexane-3, and 2,5-dimethyl-2,5-di(t-butylperoxy)hexyne-3, and mixtures comprising one or more of the foregoing cure initiators. The cure initiator, when used, can be present in an amount of 0.01 weight percent to 5 weight percent, based on the total weight of the phase-change composition.

Crosslinking agents are reactive monomers or polymers. In an embodiment, such reactive monomers or polymers are capable of co-reacting with the polymer in the phase-change composition. Examples of suitable reactive monomers include styrene, divinyl benzene, vinyl toluene, triallylcyanurate, diallylphthalate, and multifunctional acrylate monomers (such as Sartomer compounds available from Sartomer Co.), among others, all of which are commercially available. Useful amounts of crosslinking agents are 0.1 to 50 weight percent, based on the total weight of the phase-change composition.

Exemplary antioxidants include radical scavengers and metal deactivators. A non-limiting example of a free radical scavenger is poly[[6-(1,1,3,3-tetramethylbutyl)amino-s-triazine-2,4-diyl][(2,2,6,6,-tetramethyl-4-piperidyl)imino]hexamethylene[(2,2,6,6-tetramethyl-4-piperidyl)imino]], commercially available from Ciba Chemicals under the tradename Chimassorb 944. A non-limiting example of a metal deactivator is 2,2-oxalyldiamido bis[ethyl 3-(3,5-di-t-butyl-4-hydroxyphenyl)propionate] commercially available from Chemtura Corporation under the tradename Naugard XL-1. A single antioxidant or a mixture of two or more antioxidants can be used. Antioxidants are typically present in amounts of up to 3 weight percent, specifically 0.5 to 2.0 weight percent, based on the total weight of the phase-change composition.

Coupling agents can be present to promote the formation of or participate in covalent bonds connecting a metal surface or filler surface with a polymer. Exemplary coupling agents include 3-mercaptopropylmethyldimethoxy silane and 3-mercaptopropyltrimethoxy silane and hexamethylenedisilazanes.

When an additive is present, the phase-change composition can comprise 40 to 95 weight percent, or 50 to 90 weight percent, or 60 to 85 weight percent, or 70 to 80 weight percent of the unencapsulated phase-change material; 2 to 40 weight percent, or 4 to 30 weight percent, or 5 to 20 weight percent, or 5 to 15 weight percent of the thermoplastic polymer composition; and up to 60 weight percent, or 0.1 to 40 weight percent, or 0.5 to 30 weight percent or 1 to 20 weight percent of an additive composition; wherein each weight percent is based on the total weight of the phase-change composition and totals 100 weight percent.

The phase-change composition comprising the unencapsulated phase-change material, the thermoplastic polymer composition, and at least one additive is a gel at a temperature of less than or equal to 100° C., or less than or equal to 80° C., or less than or equal to 50° C., or less than or equal to 30° C., and can have a viscosity of less than 100,000 centipoise, or less than 55,000 centipoise, or less than 30,000 centipoise, or less than 20,000 centipoise, or less than 10,000 centipoise, or less than 3000 centipoise at temperatures of at least 120° C. In an embodiment, the phase-change composition is a gel at a temperature of less than or equal to 80° C., or less than or equal to 50° C., and has a viscosity of less than 55,000 centipoise, or less than 30,000 centipoise, or less than 20,000 centipoise, or less than 10,000 centipoise, or less than 3000 centipoise at temperatures of 120° C. In another embodiment, the phase-change composition is a gel at a temperature of less than or equal to 50° C., and has a viscosity of less than 30,000 centipoise, or less than 20,000 centipoise, or less than 10,000 centipoise, or less than 3000 centipoise at temperatures of 120° C.

The phase-change composition comprising at least one additive can have a heat of fusion of at least 100 J/g, preferably at least 170 J/g, more preferably at least 220 J/g, yet more preferably at least 240 J/g.

In some embodiments, the phase-change composition comprising at least one additive can meet the UL94 V-2 flammability standard.

The phase-change composition can be manufactured by combining the thermoplastic polymer composition, the phase-change material, optionally a solvent, and any additives to manufacture the phase-change composition. The combining can be by any suitable method, such as blending, mixing, or stirring. In an embodiment, the phase-change material is molten and the polymer is dissolved in the molten phase-change material. In an embodiment, the components used to form the phase-change composition, including the polymer and the phase-change material and the optional additives, can be combined by being dissolved or suspended in a solvent to provide a mixture or solution.

The solvent, when included, is selected so as to dissolve the polymer, disperse the phase-change material and any other optional additives that can be present, and to have a convenient evaporation rate for forming and drying. A non-exclusive list of possible solvents is xylene; toluene; methyl ethyl ketone; methyl isobutyl ketone; hexane, and higher liquid linear alkanes, such as heptane, octane, nonane, and the like; cyclohexane; isophorone; various terpene-based solvents; and blended solvents. Specific exemplary solvents include xylene, toluene, methyl ethyl ketone, methyl isobutyl ketone, and hexane, and still more specifically xylene and toluene. The concentration of the components of the composition in the solution or dispersion is not critical and will depend on the solubility of the components, the filler level used, the method of application, and other factors. In general, the solution comprises 10 to 80 weight percent solids (all components other than the solvent), more specifically 50 to 75 weight percent solids, based on the total weight of the solution.

Any solvent is allowed to evaporate under ambient conditions, or by forced or heated air, and the mixture is cooled to provide a gelled phase-change composition. The phase-change composition can also be shaped by known methods, for example extruding, molding, or casting. For example, the phase-change composition can be formed into a layer by casting onto a carrier from which it is later released, or alternatively onto a substrate such as a conductive metal layer that will later be formed into a layer of a circuit structure.

The layer can be uncured or partially cured (B-staged) in the drying process, or the layer can be partially or fully cured, if desired, after drying. The layer can be heated, for example at 20 to 200° C., specifically 30 to 150° C., more specifically 40 to 100° C. The resulting phase-change composition can be stored prior to use, for example lamination and cure, partially cured and then stored, or laminated and fully cured.

In another aspect, an article comprising the phase-change composition is disclosed. The phase-change composition can be used in a variety of applications, including electronic devices, LED devices, and batteries. The phase-change composition can be used with particular advantage in articles containing irregularly-shaped cavities that can be difficult to fill completely with solid PCM composites and materials. The phase-change composition can be used in a wide variety of electronic devices and any other devices that generate heat to the detriment of the performance of the processors and other operating circuits (memory, video chips, telecom chips, and the like). Examples of such electronic devices include cell phones, PDAs, smart-phones, tablets, laptop computers, hand-held scanners, and other generally portable devices. However, the phase-change composition can be incorporated into virtually any electronic device that requires cooling during operation. For example, electronics used in consumer products, medical devices, automotive components, aircraft components, radar systems, guidance systems, and GPS devices incorporated into civilian and military equipment and other vehicles can benefit from aspects of the various embodiments, such as batteries, engine control units (ECU), airbag modules, body controllers, door modules, cruise control modules, instrument panels, climate control modules, anti-lock braking modules (ABS), transmission controllers, and power distribution modules. The phase-change composition and articles thereof can also be incorporated into the casings of electronics or other structural components. In general, any device that relies on the performance characteristics of an electronic processor or other electronic circuit can benefit from the increased or more stable performance characteristics resulting from utilizing aspects of the phase-change compositions disclosed herein.

The cavity of the article can be of any shape or size. As described above, however, the phase-change composition is especially useful for small cavities or cavities with intricate features, because such cavities can be readily filled using the phase-change compositions. In an embodiment, the cavity of the article has a smallest dimension of less than 2 centimeters, preferably less than 1 centimeter, more preferably less than 0.5 centimeter, yet more preferably less than 0.1 centimeter. In an alternative embodiment, the cavity of the article has a smallest dimension of least 2 centimeters or more, or 5 centimeters or more, or 10 centimeters or more, or 20 centimeters or more. The article can be, for example, an electronic device, preferably a hand-held electronic device. Other articles can be an LED device or a battery, for example an automobile battery.

An article comprising the phase-change composition can be manufactured by heating the phase-change composition to a temperature of at least 100° C., or at least 110° C., or at least 120° C. to obtain a fluid phase-change composition and then introducing the fluid phase-change composition into a cavity of an article at a first temperature, and cooling the article to a second temperature. The viscosity of the fluid phase-change composition is less than 100,000 centipoise, or less than 55,000 centipoise, or less than 30,000 centipoise, or less than 20,000 centipoise, or less than 10,000 centipoise, or less than 3000 centipoise at the first temperature. Introducing the fluid phase-change composition into the cavity can be performed by gravity, for example pouring or dropping. In a specific embodiment, introducing the fluid phase-change composition into the cavity can be performed by injecting. The phase-change composition within the article at a second temperature that is no more than the expected maximal temperature of operation of the article forms a gelled phase-change composition. The second temperature (gel temperature of the composition) can be less than or equal to 100° C., or less than or equal to 80° C., or less than or equal to 50° C., or less than or equal to 30° C., for example 25 to 100° C., or 28 to 60° C., or 45 to 85° C., or 60 to 80° C., or 80 to 99° C.

The phase-change compositions described herein can provide improved thermal stability to the device, resulting in the ability to avoid degradation of performance and lifetime of the electronic devices. The phase-change compositions are further advantageous for use as thermal management materials, especially in electronics, because they can easily be introduced into cavities of irregular shapes that can be difficult to fill completely with solid phase-change composition, permitting maximum heat absorption capacity.

The following example is merely illustrative of the phase-change composition and method of manufacture disclosed herein and is not intended to limit the scope hereof.

### EXAMPLE

The melting temperature and enthalpy (ΔH) of the transition of a material can be determined by differential scanning calorimetry (DSC), e.g., using a Perkin Elmer DSC4000, or equivalent, according to ASTM D3418.

A material with a viscosity at temperatures of greater than or equal to 100° C. suitable for injection was made by gradually dissolving 7.3 grams of KRATON D1192 (a clear linear block copolymer based on styrene and butadiene with bound styrene of 30% mass) in 78 grams of melted PCM43P (paraffin wax with a phase-change temperature at 43° C.; Microtek Laboratories, Inc.) with mixing in a planetary Ross mixer. The set up temperature for the Ross mixer was 100° C. After the polymer was fully dissolved into the melted wax, 14.7 grams of alumina trihydrate (ATH) SB 222 (Huber Engineered Materials) and 0.1 gram Regal 660R carbon black were gradually added into the melted system until a homogenous phase-change composition was formed.

DSC is performed on the phase-change composition to determine the heat of fusion. The FIGURE presents the DSC results showing the phase-change composition has a high heat of fusion, 204.8 J/g.

The viscosity of the phase-change composition at 100° C. is below 5000 centipoise (cP), as determined using a Brookfield RVDV2T Rotational Viscometer with a Thermosel temperature controller according to ASTM Standard D 3236-88, permitting injection of the phase-change composition into a desired location. However, at lower temperatures (e.g., <60° C.), the phase-change composition is a non-flowing gel that does not leak from the location.

The claims are further illustrated by the following embodiments, which are non-limiting.

Embodiment 1: A phase-change composition comprising: a homogeneous mixture of a thermoplastic polymer composition; and a phase-change material; wherein the phase-change composition has a viscosity of less than 100,000 centipoise, or less than 55,000 centipoise, or less than 30,000 centipoise, or less than 20,000 centipoise, or less than 10,000 centipoise, or less than 3000 centipoise at a temperature greater than or equal to 120° C. and is a gel at a temperature less than or equal to 100° C., or less than or equal to 80° C., or less than or equal to 50° C.

Embodiment 2: The phase-change composition of embodiment 1, wherein the thermoplastic polymer composition comprises an elastomeric block copolymer, an elastomeric graft copolymer, an elastomeric random copolymer, or a combination thereof; preferably the thermoplastic polymer composition comprises a styrene-ethylene/propylene-styrene block copolymer, a styrene-ethylene/butylene-styrene block copolymer, a styrene-butadiene rubber, an ethylene-vinyl acetate copolymer, a polybutadiene, an isoprene, a polybutadiene-isoprene copolymer, an ethylene-propylene rubber, an ethylene-propylene-diene monomer rubber, a natural rubber/isoprene, a butyl rubber, nitrile rubber, or a combination thereof; more preferably the thermoplastic polymer composition comprises a styrene-ethylene/propylene-styrene block copolymer, a styrene-ethylene/butylene-styrene block copolymer, or a combination thereof.

Embodiment 3: The phase-change composition of any one or more of embodiments 1 to 2, wherein the phase-change material comprises a C10-35 alkane, C10-35 fatty acid, C10-35 fatty acid ester, or a vegetable oil; preferably a C18-28 alkane, C18-28 fatty acid, or C18-28 fatty acid ester.

Embodiment 4: The phase-change composition of any one or more of embodiments 1 to 3, further comprising an additive composition, wherein the additive composition comprises an encapsulated phase-change material, a flame retardant, a thermal stabilizer, an antioxidant, a thermoconductive filler, a thermally insulating filler, a magnetic filler, a colorant, or a combination thereof.

Embodiment 5: The phase-change composition of embodiment 4, wherein the flame retardant is a metal carbonate, a metal hydrate, a metal oxide, a halogenated organic compound, an organic phosphorus-containing compound, a nitrogen-containing compound, a phosphinate salt, or a combination thereof; preferably wherein the flame retardant is aluminum trihydroxide, magnesium hydroxide, antimony oxide, decabromodiphenyl oxide, decabromodiphenyl ethane, ethylene-bis (tetrabromophthalimide), melamine, zinc stannate, boron oxide, or a combination thereof.

Embodiment 6: The phase-change composition of any one or more of embodiments 1 to 5, comprising 40 to 95 weight percent, or 50 to 90 weight percent, or 60 to 85 weight percent, or 70 to 80 weight percent of the unencapsulated phase-change material; 2 to 40 weight percent, or 4 to 30 weight percent, or 5 to 20 weight percent, or 5 to 15 weight percent of the thermoplastic polymer composition; and up to 60 weight percent, or 0.1 to 40 weight percent, or 0.5 to 30 weight percent or 1 to 20 weight percent of an additive composition; wherein each weight percent is based on the total weight of the phase-change composition and totals 100 weight percent.

Embodiment 7: The phase-change composition of any one or more of embodiments 1 to 6, having a heat of fusion, determined by differential scanning calorimetry according to ASTM D3418, at the melting temperature of at least 150 Joules/gram, preferably at least 180 Joules/gram, more preferably at least 200 Joules/gram.

Embodiment 8: The phase-change composition of any one or more of embodiments 1 to 7, wherein the phase-change material has a melting temperature of 5 to 70° C., preferably 25 to 65° C., more preferably 35 to 60° C., yet more preferably 30 to 50° C.

Embodiment 9: The phase-change composition of any one or more of embodiments 1 to 8, meeting the UL94 VTM-2 flammability standard.

Embodiment 10: A method of manufacturing a phase-change composition comprises combining a composition comprising a thermoplastic polymer composition and optionally a solvent, and molten phase-change material to form a mixture; cooling the mixture to provide a phase-change composition that is a gel at a temperature less than or equal to 100° C., or less than or equal to 80° C., or less than or equal to 50° C., and optionally removing the solvent.

Embodiment 11: The method of embodiment 10, wherein the mixture is cooled to a temperature of less than or equal to 100° C., or less than or equal to 80° C., or less than or equal to 50° C.

Embodiment 12: An article comprising the phase-change composition of any one or more of embodiments 1 to 9 or made by the method of any one or more of embodiments 10 to 11.

Embodiment 13: The article of embodiment 12, wherein the phase-change composition is disposed in a cavity of the article.

Embodiment 14: The article of embodiment 13, wherein the cavity has a smallest dimension of less than 2 centimeters, preferably less than 1 centimeter, more preferably less than 0.5 centimeter.

Embodiment 15: The article of any one of embodiments 12 to 14, wherein the article is an electronic device, preferably a hand-held electronic device, an LED device, or a battery.

Embodiment 16: A method of manufacturing an article comprising a phase-change composition, the method comprising heating the phase-change composition of any one or more of embodiments 1 to 9 or made by the method of any one or more of embodiments 10 to 11 at a temperature effective to provide a viscosity of less than 100,000 centipoise, or less than 55,000 centipoise, or less than 30,000 centipoise, or less than 20,000 centipoise, or less than 10,000 centipoise, or less than 3000 centipoise, preferably wherein the viscosity of the heated phase-change composition is less than 30,000 centipoise and the temperature is at least 100° C.; introducing the heated phase-change composition into a cavity of an article; and cooling the introduced phase-change composition to form a gelled phase-change composition within the cavity.

Embodiment 17: The method of embodiment 16, wherein the introduced phase-change composition is cooled to a temperature of less than or equal to 100° C., or less than or equal to 80° C., or less than or equal to 50° C.

Embodiment 18: The method of embodiment 16 or embodiment 17, wherein the cavity has a smallest dimension of less than 2 centimeters, preferably less than 1 centimeter, more preferably less than 0.5 centimeter.

Embodiment 19: The method of any one or more of embodiments 16 to 18, wherein the article is an electronic device, preferably a hand-held electronic device, an LED device, or a battery.

In general, the articles and methods described here can alternatively comprise, consist of, or consist essentially of, any components or steps herein disclosed. The articles and methods can additionally, or alternatively, be manufactured or conducted so as to be devoid, or substantially free, of any ingredients, steps, or components not necessary to the achievement of the function or objectives of the present claims.

The singular forms “a,” “an,” and “the” include plural referents unless the context clearly dictates otherwise. “Or” means “and/or.” Unless defined otherwise, technical and scientific terms used herein have the same meaning as is commonly understood by one of skill in the art to which the claims belong. A “combination” is inclusive of blends, mixtures, alloys, reaction products, and the like. The values described herein are inclusive of an acceptable error range for the particular value as determined by one of ordinary skill in the art, which will depend in part on how the value is measured or determined, i.e., the limitations of the measurement system. The endpoints of all ranges directed to the same component or property are inclusive of the endpoints and intermediate values, and independently combinable. In a list of alternatively useable species, “a combination thereof” means that the combination can include a combination of at least one element of the list with one or more like elements not named. Also, “at least one of” means that the list is inclusive of each element individually, as well as combinations of two or more elements of the list, and combinations of at least one element of the list with like elements not named.

Unless specified otherwise herein, all test standards are the most recent standard in effect as of the filing date of this application, or, if priority is claimed, the filing date of the earliest priority application in which the test standard appears. Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosed subject matter is described herein in terms of some embodiments and representative examples, those skilled in the art will recognize that various modifications and improvements can be made to the disclosed subject matter without departing from the scope thereof. Additional features known in the art likewise can be incorporated. Moreover, although individual features of some embodiments of the disclosed subject matter can be discussed herein and not in other embodiments, it should be apparent that individual features of some embodiments can be combined with one or more features of another embodiment or features from a plurality of embodiments.

What is claimed is:

1. A method of manufacturing an electronic device comprising a phase-change composition, the method comprising
heating a phase-change composition at a temperature effective to provide a viscosity of less than 5000 centipoise;
introducing the heated phase-change composition into a cavity of an electronic device; and
cooling the introduced phase-change composition to form a gelled phase-change composition within the cavity,
wherein the phase-change composition comprises a homogeneous mixture of a thermoplastic polymer composition; and
70 to 97 weight percent of a phase-change material, wherein the phase-change material has a melting temperature of 35 to 50° C., wherein weight percent is based on the total weight of the phase-change composition;
wherein the phase-change composition has a viscosity of less than 5000 centipoise at a temperature greater than or equal to 100° C. and is a gel at a temperature less than or equal to 60° C.

2. The method of claim 11, wherein the cavity has a smallest dimension of less than 2 centimeters.

3. The method of claim 1, wherein the introducing is by injecting.

4. The method of claim 1, wherein the electronic device is a hand-held electronic device, an LED device, or a battery.

5. The method of claim 1, wherein the introduced phase-change composition is cooled to a temperature of less than or equal to 60° C.

6. The method of claim 1, wherein the thermoplastic polymer composition comprises an elastomeric block copolymer, an elastomeric graft copolymer, an elastomeric random copolymer, or a combination thereof.

7. The method of claim 1 wherein the phase-change material comprises an alkane, a fatty acid, a fatty acid ester, or a vegetable oil.

8. The method of claim 1, wherein phase-change composition further comprises an additive composition, wherein the additive composition comprises an encapsulated phase-change material, a flame retardant, a thermal stabilizer, an antioxidant, a thermoconductive filler, a thermally insulating filler, a magnetic filler, a colorant, or a combination thereof.

9. The phase-change composition of claim 8, wherein the flame retardant comprises a metal carbonate, a metal hydrate, a metal oxide, a halogenated organic compound, an organic phosphorus-containing compound, a nitrogen-containing compound, a phosphinate salt, or a combination thereof.

10. The method of claim 8, wherein the phase-change composition comprises 0.5 to 20 weight percent of the additive composition; wherein weight percent is based on the total weight of the phase-change composition and totals 100 weight percent.

11. The method of claim 1, wherein the phase-change composition has a heat of fusion, determined by differential scanning calorimetry according to ASTM D3418, at the melting temperature of at least 150 Joules/gram.

12. The method of claim 1, wherein the phase-change composition meets the UL94 VTM-2 flammability standard.

13. An electronic device made by the method of claim 1, wherein the cavity has a smallest dimension of less than 2 centimeters, and the electronic device is a hand-held electronic device, an LED device, or a battery.
